(19) United States
(12) Patent Application Publication
(10) Pub. No.: US 2008/0264353 A1
(43) Pub. Date: Oct. 30, 2008

(54) Water Heating Device

(76) Inventor: Aviam Eli, Tel Aviv (IL)

Correspondence Address: YORAM TSIVION, P.O. BOX 1307, PARDES HANNA, 37111, IL

(21) Appl. No.: 11/910,266

(22) PCT Filed: Mar. 30, 2006
(86) PCT No.: PCT/IL2006/000400

§ 371 Date: Sep. 30, 2007

(30) Foreign Application Priority Data
Mar. 31, 2005 (IL) 167814

(51) Int. Cl. F24H 1/00; B67D 5/63

(52) U.S. Cl. 122/13.01; 222/146.2

(57) ABSTRACT

A water heating device including at least two water tanks. In the first water tank water is heated by a heating element. The intermediate water tank is located above the first tank, and feeds colder water into it, through a pipe. In some embodiments a condenser of water vapour is connected to the intermediate tank. A water discharge tap for hot water drains the first tank.

### FIELD OF THE INVENTION

The present invention relates in general to systems providing hot and cold drinking water. More specifically the present invention relates to systems providing drinking water having an un-pressurized hot water tank.

### BACKGROUND OF THE INVENTION

A system for dispensing high quality drinking water usually includes a water heating subsystem. Basically two different methods are employed in such systems for heating the water. Such are open tank heating or sealed and pressurized tank heating.

Both methods have respective drawbacks. When an open tank is employed the water does not really boil and the discharged water only reaches a temperature of about 95° C. Another common drawback of such a system is spillage of water from the unsealed tank due to bubbling. Water heating devices employing pressurized tanks provide for boiling but at comparatively high cost.

### BRIEF DESCRIPTION OF THE DRAWINGS

FIG. 1 is a schematic description of a water dispensing device of the invention.

### DETAILED DESCRIPTION OF THE PRESENT INVENTION

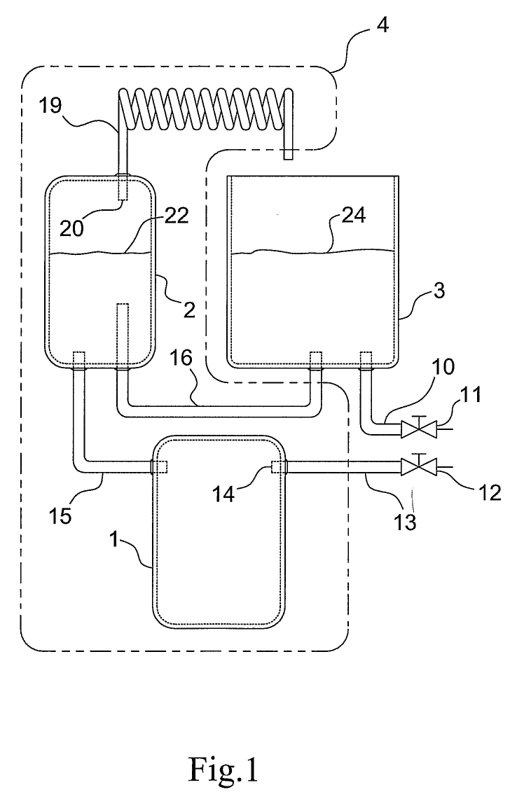

Reference is made to FIG. 1 in which a water dispensing device in accordance with the instant invention is described schematically. The device includes three water tanks, hot tank 1, intermediate tank 2 and cold tank 3. Intermediate tank 2 and cold tank 3 are located substantially at the same level whereas hot tank 1 is located below intermediate tank 2. Water is fed from the cold tank to the hot tank through the intermediate tank by gravity, as will be explained infra. The cold tank is fed from the home water system, or by way of a mobile container such as a 20 liter bottle, which is typically used for delivering spring water. Pipe 10 connects cold tank 3 with cold-water tap 11. In some variants of the present invention an additional cold tank is located below cold tank 3. In such cases, pipe 10 feeds this additional cold tank. A dedicated cooling device, not shown, cools the additional cold tank when present, or alternatively it may cool tank 3.

Entire heating subsystem 4 of a preferred embodiment of the invention consists of hot tank 1, intermediate tank 2, and the interconnecting pipes between these tanks. Intermediate tank 2 and cold tank 3 are connected such that the level of water in both tanks is the same. In some variants of the present invention, a unidirectional valve is installed at the water outlet of cold tank 3. Alternatively, water is directly fed into intermediate tank 2 from the home water system, or the mobile container. Such embodiments promote energy saving through minimizing heat transfer from the heating subsystem to the cold tank as will be described infra.

THot tap 12 is connected by means of pipe 13 to the hot tank 1. Outlet aperture 14 of the hot tank is located at its upper part so that water of higher temperature is discharged through tap 12. Water from intermediate tank 2 feeds hot tank 1 through pipe 15 by gravity. Pipe 16 connects between intermediate tank 2 and cold tank 3. Both intermediate and cold tank are typically connected through their respective bottom parts. However, pipe 16 preferably extends into the lumen of the intermediate tank so that it is remotely located from the aperture of pipe 15. Intermediate tank 2 is also fed by gravity with water from the cold tank 3 through pipe 16. Tank 2 practically serves as a deaerator for the heating subsystem. Variants of the invention may consist of multiple intermediate tanks for the purpose of high throughput of discharged hot water.

Condenser 19 is a spiral pipe connected to the topside of the intermediate tank 2. The other end of pipe 19 is open to the atmosphere and is located above the opening of cold tank 3. Since the intermediate tank is unsealed, its water level 22 is the same as water level 24 in the cold tank. Hot tank I is practically sealed by the water contained in intermediate tank 2. Hot water and vapors pass through pipe 15 to the intermediate tank 2, providing pre-heating to the water contained in the intermediate tank thus promoting energy saving. When hot tank 1 is heated, the water at tank 2 provides a seal which helps maintain a pressure which is slightly above the atmospheric pressure, which in turn provides for higher hot water temperatures. Furthermore, hot spillage is avoided and steam bubbles do not interrupt the discharge flow of hot water through hot-water tap 12. The hot tank is heated by a heating element, not shown.- Such a heating element typically consists of an electrical heating device immersed in the water, or heating is provided by the combustion of gas or any fuel.

Variants in which more than one pipe connects between tank 1 and 2, namely feeding water into tank 1 can be carried out using a separate pipe than the pipe in which vapors and hot water flow back to tank 2. Optional condenser 19 condenses vapors coming out of intermediate tank 2. The condensed water accumulates in the lower sections of the spiral loops. Such condensed water is eventually pushed by vapors to cold tank 3 but some may flow back to intermediate tank 2.

A functional unit providing drinking water according to the present invention includes the parts and components described above, assembled and installed in a cabin in which the cold and the hot-water taps protrude from its front panel. The level of water in the cold tank is retained at a predetermined value by means of a device such as a height gauge. Air bubbles initially trapped in tank 1 are released through the deaerator during initial system operation.

1. A water heating device comprising:
a first water tank in which water is heated by a heating element;
at least one intermediate water tank located above said first tank;
at least one pipe for connecting said first with said at least one intermediate tanks;
a water discharge tap for hot water connected to said first tank.

2. A water heating device as in claim 1, further comprising at least one condenser for water vapour disposed at the top of said at least one of said intermediate water tanks.

3. A water dispensing device comprising:
a first water heating tank;
a second tank for cold water storage;
at least one intermediate tank located at a level above said first tank, and
at least one pipe for connecting said first tank with said at least one intermediate tank.

4. A water dispensing device as in claim 3, in which said second tank is connected by a pipe with said at least one intermediate tank.

5. A water dispensing device as in claim 3, further including at least one condenser for water vapour disposed at the top of said at least one intermediate tank.

6. A water dispensing device as in claim 4, further comprising a unidirectional valve connecting between said second tank and said at least one intermediate tank.

7. A method for heating water in a cold and hot water drinking water dispensing device, comprising feeding water to a heated water tank by gravity wherein said fed water is taken out of at least one intermediate tank, and wherein water in said intermediate tank keep an opening of said heated water tank closed and wherein bubbles and vapours resulting from heated water are passed on to said intermediate tank.

8. A method as in claim 7, further comprising keeping the water level in said at least one intermediate tank level with the water level in a cold water tank.
